(19) United States
(12) Patent Application Publication
(10) Pub. No.: US 2021/0016851 A1
(43) Pub. Date: Jan. 21, 2021

(54) MOTORCYCLE GAUGE WITH ARTICULATING TRANSPARENT DISPLAY

(71) Applicant: Continental Automotive Systems, Inc., Auburn Hills, MI (US)

(72) Inventor: Daniel Arthur Brudzynsky, West Bloomfield, MI (US)

(21) Appl. No.: 16/511,391

(22) Filed: Jul. 15, 2019

(51) Int. Cl. B62J 99/00; G01C 21/26

(52) U.S. Cl. CPC B62J 99/00; B62J 2099/0026; G01C 21/265

(57) ABSTRACT

The functionality of two gauges is provided in the dashboard space required by one gauge by an articulating transparent display, which is attached to another, in-dash gauge using a hinge.

As used herein, the term “motorcycle” refers to a two-wheeled or three-wheeled automotive vehicle for one or two people. The term, “gauge” refers to an instrument having a graduated scale or dial for measuring or indicating quantity. “Dashboard” refers to a panel extending across the interior or the front of a vehicle, below the windshield and usually containing instruments such as a speedometer or controls. The term “articulate” as a verb means united by or connected by a joint. “Articulating,” which is used herein as a verb, should be construed to mean moving or movable.

When compared to trucks and automobiles, motorcycles have relatively little area for gauges. A gauge that “fits” within the form factor or shape of a motorcycle dashboard and which can display or provide more information to the motorcycle driver would be an improvement over the prior art.

### BRIEF DESCRIPTION OF THE FIGURES

FIG. 1 depicts a motorcycle gauge with an articulating transparent display in a first position; and.

FIG. 2 depicts the motorcycle gauge shown in FIG. 1 in a second position.

### DETAILED DESCRIPTION

Put simply, this disclosure is directed to a gauge for use with a motorcycle and which provides the functionality of two gauges using a dashboard “footprint” or space of one gauge. That two-gauge functionality in the space required by a single gauge is provided by an articulating transparent display that swings or rotates on an axis between two positions.

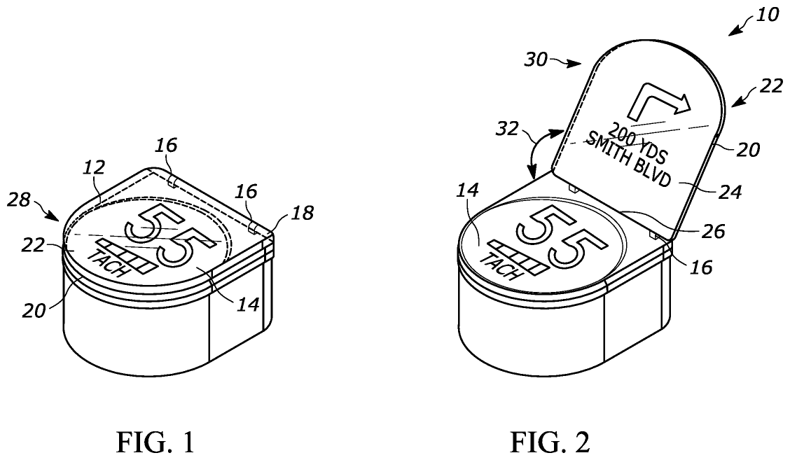

Referring now to FIG. 1, a motorcycle gauge with an articulating transparent display 10 comprises a first gauge 12 that itself comprises a first, substantially planar surface 14 on which a first type of information can be displayed. Examples of such information include but are not limited to, vehicle speed, engine speed, fuel tank level and the like.

As used herein, a hinge comprises two wings, which are usually plate-like structures that are sized and shaped to be attached to two structures that are supposed to “rotate” relative to each other. Each hinge wing has a knuckle, which is designed or configured such that the knuckle of one wing inter-engages the knuckle of the other wing. A pin or rod extending through the knuckles of the wings is essentially an axle or an “axis” around which the wings can rotate thereby allowing structures attached to the wings to rotate around the axis. In FIG. 1, one wing (or equivalent) of a hinge 16 is attached to an edge of the first gauge 12. As with all hinges, the hinge 16 has an axis 18 around which a second wing can rotate between first and second positions.

A second, plate-like and substantially planar gauge 20 is attached to the second wing of the hinge 16. A pin extending through the wings of the hinge 16 allow the second gauge 20 to rotate around the pin between at least two different positions.

It can be seen in the figures that the second gauge 20 comprises a first substantially planar side 22 and an opposing second, substantially planar side (24). The second gauge 20 is made of an organic light-emitting diode (OLED) display and is transparent.

As shown in FIG. 1, the second gauge and the first gauge have the same or at least nearly the same size and shape such that the second gauge 20 can lay flat and directly on top of the first gauge. When the second gauge 20 is “lifted” off its “first” position, which is on top of the first gauge, and rotated around the axis 16 to a second or “deployed” position as shown in FIG. 2, the OLED display in the second gauge 20 can be energized to display other information. In FIG. 2, the second gauge 20 is used to display navigation information, which is considered herein as being a second “type” of information and which is different from the type of information displayed on the first gauge.

When the second gauge 20 is in its “first” position, shown in FIG. 1, the angle 32 between the two gauges 12 and 20 is approximately zero degrees thereby allowing information on the first gauge to be visible through the second gauge. When the gauge is in a “second” position, such as the position shown in FIG. 2, the angle 32 between the two gauges 12 and 20 can be virtually any angle between about ninety degrees and one-hundred eighty degrees. When the second gauge 20 in a “second” position, the second gauge 20 displays a second type of information. In the preferred embodiment, the second gauge 20 displays navigation information, which can include either direction or position information.

The foregoing description is for illustration purposes only. The true scope of the invention is set forth in the following claims.

What is claimed is:

1. A motorcycle gauge comprising:
a first gauge comprising a first, substantially planar surface on which a first type of information can be displayed, the first gauge also comprising a first part of a two-part hinge (16), the hinge having an axis around which a second part of the two-part hinge can rotate between first and second positions;
a second, plate-like and substantially planar gauge comprising a first side and an opposing second side on which a second type of information can be displayed, the second plate-like gauge also comprising the second part of the two-part hinge, the second gauge being configured to rotate about said axis of rotation between first and second positions by rotation of the second gauge around said axis, the second, plate-like gauge being substantially transparent when it is in the first position, which is at approximately zero degrees thereby allowing information on the first gauge to be visible through the second gauge, the second gauge displaying a second type of information when it is in the second position.

2. The motorcycle gauge of claim 1, wherein the second gauge is directly atop the first gauge when the second gauge is in the first position and wherein the second gauge is inclined at a first angle (32) relative to the first gauge when the second gauge is in the second position.

3. The motorcycle gauge of claim 2, wherein the first angle is between about ninety degrees and about one-hundred eighty degrees relative to the first gauge.

4. The motorcycle gauge of claim 2, wherein the first type of information is not navigation information, wherein the second type of information is navigation information.

5. The motorcycle gauge of claim 4, wherein navigation information consists of at least one of: a direction or travel and a geographic location.

6. The motorcycle gauge of claim 1, wherein the second, plate-like gauge comprises an organic light emitting diode.
